(19) United States
(12) Patent Application Publication
(10) Pub. No.: US 2002/0002502 A1
(43) Pub. Date: Jan. 3, 2002

(54) Product brokering method and system

(76) Inventors: Patricia Maes, Cambridge, MA (US); Ankur Chandra, Santa Clara, CA (US)

Correspondence Address: TESTA, HURWITZ & THIBEAULT, LLP, HIGH STREET TOWER, 125 HIGH STREET, BOSTON, MA, 02110, US

(21) Appl. No.: 09/839,498

(22) Filed: Apr. 20, 2001

Related U.S. Application Data
(60) Provisional application No. 60/205,682, filed on May 19, 2000.

(51) Int. Cl. G06F 17/60

(52) U.S. Cl. 705/26

(57) ABSTRACT

In accordance with the present invention, a computer-based tool helps a person choose a product from among many possible products. This assistance, sometimes referred to as product brokering, can be useful in electronic commerce for facilitating customer selection of products. An embodiment of the invention enables product selection by a person even if the person is unable to precisely or even explicitly specify what product features or characteristics the person desires. The person is presented with a relatively small set of possible products for comparison, and the computer-based tool solicits opinions from the person about the presented products. The computer-based tool extracts information about product characteristics that appeal to or repulse the person, and uses the extracted information to present the person with additional product choices. With each iteration of product presentation by the computer-based tool and expression of preferences by the person, an optimal product is identified.

### RELATED APPLICATION

This application claims priority to U.S. Provisional patent application Ser. No. 60/205,682, filed May 19, 2000, entitled “Method and Apparatus Facilitating Online Product Selection.”

### TECHNICAL FIELD

This invention relates to computer systems and, more particularly, to a computer-based system and method to facilitate efficient searching for a product by user.

### BACKGROUND INFORMATION

Computer-based product brokering systems-systems that broker products to user—serve as an interface to a consumer or business customer interacting with an electronic commerce system. Product brokering systems generally provide information about products and allow a user to identify one or more desired products. Some systems can transact the purchase of the desired products. Computer-based product brokers are used both over the Internet, generally using the World Wide Web (hereinafter, the Web), and in retail locations, to help customers identify and purchase products.

Current product-brokering systems fall into one of three categories: searching, browsing, and recommendation systems. Each is limited by its underlying assumptions regarding user's ability to specify what the users are looking for, and so each of these systems often fail to provide a satisfactory shopping experience.

Many product-brokering systems include a search engine. Typically, a search engine provides a field for the user to enter a text description of the product the user is looking for, and a mechanism for the user to request a search based on that text. The search engine returns a rank-ordered list of search results, based on a comparison of the entered text description with an indexed list of product descriptions. If a user can specify his desires in a text field, search systems are quite efficient, but search engines have an underlying requirement that user be able to precisely specify his desired product in a textual format.

Another disadvantage of search engines is that the user often must use the same words used to index the product. For example, if the user wants a car with manual transmission, but the product is indexed using the term “standard transmission” or “stick shift,” both synonyms for manual transmission, the search engine will not find it. Also, if the user does not speak the language used to index the search engine, searching may not be possible. Search engines frequently attempt to include the use of synonyms, but there are still semantic limitations.

Browsing-based product brokering systems are organized like a catalog. The user explores all products within a product subspace. These systems do not direct users to products they would like; rather, they present categories of products, called ontologies, for the user to choose from, and then show the products in those categories. Ontologies facilitate browsing by reducing the examined subspace, but provide further limitations on the characterization of products searched. In a large product space, the user navigates through a hierarchical ontology to ascertain the desired type of product. If the product space has n products and the user navigates the ontology to m levels deep (typically two to five levels in an e-commerce setting), each subspace is roughly of size ^{n/}₂m. Thus, the ontology greatly reduces the size of the examined subspace. An ontology generally is constructed so that products in the same subspace will have similar characteristics. In order to follow the ontology, the user has to have some knowledge of the product space beforehand, and the user's view of the product space has to match the ontology. For example, white vinegar has excellent cleaning properties and is a recommended antidote for stained clothing, but if white vinegar is categorized as a food, not as a cleaning supply, a search for white vinegar in the cleaning-products category will not be successful.

A variation of an ontology system is described by Bryan, Doug, and Anatole Gershman in “Opportunistic Exploration of Large Consumer Product Spaces,” Proceedin of the ACM Conference on E-Commerce EC '99, ACM Press, 1999, pages 41-47, in which the specificity with which a user can express his desires depends on his level in the ontology. A browsing user is at the highest, or least-granular, level of the ontology. As a user more specifically categorizes his desires, he moves down to a more specific level of the product space ontology. The Andersen system still limits the user's movement to navigation up and down the pre-determined ontology tree.

Another variation of an ontology-based system is a virtual fishbowl, which allows for cross-selling across product lines and sales of products for which the user has latent desire. This system emulates a mall, with a product space partitioned by an ontology. Like other ontology-based systems, users move up and down the ontological hierarchy, and so they cannot explore easily, nor can they control the navigation.

Recommendation systems use information collected from a user to produce a set of products in which the user may be interested. Recommendation systems generally fall into one of two categories, constraint filtering and collaborative filtering systems.

Constraint-filtering recommendation systems ask the user questions about the product that the user would like to purchase. The constraint satisfaction engine returns a set of products matching these criteria. Three examples of product-brokering systems that user a constraint-satisfaction engine are Tete-a-Tete, mySimon, and PersonaLogic, all accessible via the Web. Once constraint-filtering recommendation systems ascertain the specific desired traits, they can recommend further products with similar attributes.

There is a risk, however, that the user of a constraint-filtering system may be unable to answer many of the questions and become frustrated. Many of the product attributes asked about may be irrelevant to the user, and so such a system tends to burden the user with questions the user does not care about. Additionally, constraint-based systems are often hard to iterate through as the user learns about the product space because the user needs to fill out the detailed questionnaire again. Frequently, these systems invoke hard constraints, not negotiable preferences, so it does not necessarily map to a user's approach to shopping. By forcing constraints, the system provides no exploratory possibilities, locking the user into a subspace. Finally, having to answer a detailed questionnaire before seeing a single product lessens the enjoyment of the shopping experience.

A “people like you liked” display on product-brokering websites epitomes the second type of recommendation system, collaborative filtering. By collecting information from many users regarding their preferences, collaborative-filtering systems identify users with similar tastes. When a new user gives examples of his interests, the recommendation system matches him to other users with similar interests. Then, it recommends products that these others liked.

Because individuals' interests tend to cluster, collaborative filtering systems can suggest products similar to those in which a user has manifested interest. These systems also can occasionally suggest products that are very different from the user-specified examples, yet are likely to be interesting to the consumer as they were to other similar customers. However, these capabilities depend entirely on the existing data (and the other users) of the system.

Another type of product broker, developed by Delft University of Technology, incorporates multi-dimensional scaling. Called MDS-I, for Multi-Dimensional Scaling—Interactive, the system is described in P. J. Stappers and G. Pasman, Exploring a Database through Interactive Visualised Similarity, in Proceedings of CHI '99, Pittsburgh, Pa., May 1999, pp. 184-185. MDS-I provides a two-dimensional visualization of a multi-dimensional product space. A diagram of a product space is shown, and the user can clicks on a product for more information or he can click between products to examine the subspace. The further one product lies from another, the more dissimilar are the two items. The user assigns weights to attributes so traits differing in an important attribute are further away than those that differ in a less important attribute. As most of the screen is white space, or space between products, there is less focus on the products and more focus on where the products fit into the product space. Test implementations of the MDS-I framework were developed for rollerblade, whiskey, and color- choosing product domains.

One benefit of MDS-I is the ability to navigate by clicking in the space between two objects. However, MDS-I's operation exhibits usability limitations. Since multiple dimensions are compressed into two, a two-dimensional position represents several multidimensional positions.

Accordingly, depending on the interpreted meaning of a user's click pattern, MDS-I may or may not explore the subspace that the user desires. Also, it may be difficult for users to compare products that are close to each other in the product space.

### SUMMARY OF THE INVENTION

Applicants' invention addresses many needs left unfulfilled by the prior product brokering systems. For example, when a user initially begins looking for a product, it is difficult for her to provide a detailed description of her desires. Users ascertain their needs from exposure to the product space and the attributes that differentiate products. If users have no specification of product features in mind, browsing is most appropriate, because the user is not familiar enough with the product space to specify a preferred product. Search engines or ontologies are not helpful for initial education in the product space, while browsing allows the user to get a better feel for the product space.

As a user develops a specification of a satisfactory product, searching for specific features can help the user find the desired product more quickly than browsing. As users know what they want, they can specify their desires in terms of product attributes and features. Often users have a few features in mind when they begin shopping, and develop a better idea of what they want as they have the opportunity to compare different products. An embodiment of Applicants' invention provides an appropriate combination of browsing and searching to meet this need.

In general, a search through a product space requires both exploitation and exploration. Exploitation, which is suggesting a product similar to products already determined to be favorable, involves a “hill-climbing” process which may result in a good product, but may miss an optimal one because the system may get stuck at a local maximum. To find a global maximum, a search system should examine different product subspaces as well. Exploration is consideration of other parts of a multi-dimensional space to ensure that a search is complete. An embodiment of Applicants' invention provides a balance between exploitation and exploration.

In addition, prior product brokers generally cater toward either qualitative or quantitative factors, but not both. Using car shopping as an example, while a user might have requirements such as the number of people he needs his car to accommodate, he might also desire a sleek, aesthetically pleasing automobile. A qualitative-focused product-brokering website would request a consumer pick a car type, or body styling. A quantitative product-brokering application would first solicit the user's quantitative requirements. However, shopping is neither solely a quantitative nor just a qualitative experience. An embodiment of Applicants' invention addresses both of these aspects of shopping.

In particular, shopping's qualitative and quantitative aspects each provide different comparison and merging characteristics. Irorucally, it is often possible to handle both better by treating each as the other. The qualitative aspects are, in general, represented by the product's visual image. Qualitative factors allow for easy visual comparison, yet it may not be easy to identify other products that have the same qualitative feature, as these are often difficult to delineate. It is possible, however, to account for some of these properties by enumerating related aspects on a subjective scale. For example, users can rate the product's trendiness or the average age of the product's typical owner. When quantified, these integral characteristics would facilitate identification of qualitatively similar products that have the same feature. Inherently quantitative aspects, conversely, may benefit from qualitative comparison. For example, it is easy to identify products with similar quantitative factors yet it is difficult to compare them. However, quantitative comparison is easier with a better visualization interface. An embodiment of Applicants' invention can provide a user with information about both qualitative and quantitative product features.

Trust and control are also important to user interaction with a product-brokering system. As shopping involves parting a user with his money, a consumer must trust that the system works well and operates in his interests. Like trust, user control is critical to a successful product-brokering system. Shopping is a user-driven process. Users perform better and have higher subjective satisfaction when they can view and control a search. An embodiment of Applicants's invention provides trust and control to engender a better shopping experience.

In accordance with the present invention, a computer-based tool helps a person choose a product from among many possible products. This assistance, sometimes referred to as product brokering, can be useful in electronic commerce for facilitating customer selection of products. An embodiment of the invention enables product selection by a person even if the person is unable to precisely or even explicitly specify what product features or characteristics the person desires. The person is presented with a relatively small set of possible products for comparison, and the computer-based tool solicits opinions from the person about the presented products. The tool extracts information about product characteristics that appeal to or repulse the person, and uses the extracted information to present the person with additional product choices. With each iteration of product presentations by the tool and expression of preferences by the person, products of progressively greater satisfaction are identified.

For example, a computer-based tool in accordance with the present invention can be used to help a person select an automobile from various available types. The person is presented with a random sampling of vehicles. The person selects one or more vehicles that appeal to her, and the computer-based tool determines the vehicle characteristics (e.g., fuel economy, passenger capacity, style, sportiness, and so on) that appeal to the person. The tool identifies one or more vehicles that have characteristics similar to the vehicles chosen by the person, and presents those choices to the person. The person might find one of the vehicles to her liking as a satisfactory choice, or she might pick one or more of the vehicles and try again. In the latter event, the computer-based tool again identifies automobile characteristics that appeal to the person, and offers another group of choices based on the person's preferences. This cycle can be repeated continuously until the user identifies an optimal automobile.

One implementation of such a tool allows the person to express negative preferences for displayed vehicles. Another implementation allows the person to specify particular attribute preferences directly. In both cases, this information is used, possibly in combination with the user's preferences as described above, to identify product choices that are presented to the user.

In general, in one aspect, the invention relates to a method of facilitating a search by a user for satisfactory product from among a plurality of products. The products are defined by a set of measurable attributes, and values are assigned to each measurable attribute for each product. User selection of one or more products is facilitated, and the attribute values of the selected products are combined to produce a set of progeny attribute values. One or more candidate products are selected based on the progeny attribute values, and the candidate products are presented to the user. These steps can be repeated until a satisfactory product is selected.

Selection of one or more products can be accomplished by presenting the user with a number of product options, and allowing the user to select from the options presented. The initial options presented can be a random subset of the plurality of products, or can be a predetermined subset of the plurality of products, for example, a carefully selected sample of the product space. Selection of products provides information about characteristics that the user likes and that the user finds important. The user can select one or more desired products and one or more products that are not desired. In one embodiment, this facilitating step is performed by a server computer in communication with a client computer over a computer network, where the user interacts with the client computer to communicate with the server computer. In one such embodiment, the server computer includes a web server, the client compute includes a web browser, and the computer network is the Internet.

In some embodiments, combining the attribute values of the selected products is performed in accordance with one or more various combination techniques. A combination technique can include a random probability function, for example, to tandomly modify some attributes, or to randomly select some attributes from one selected product and some attributes from another selected product. The attribute values of one or more products can be displayed and the user may be allowed to modify the displayed attribute values. In such an implementation, the method can include combining the attribute values of the selected products and the modified displayed attribute values to produce a set of progeny attribute values.

In one implementation, a combination technique includes, for each measurable attribute, choosing one of the selected products, and taking the attribute value of the chosen product as the progeny attribute value for that measurable attribute. In another implementation, the combination technique includes choosing one of the selected products and, for a subset of the measurable attributes, taking the attribute value of the chosen product as the progeny attribute value for that measurable attribute. The subset of the measurable attributes can range from just one of the measurable attributes up to and including all of the measurable attributes. Also, choosing may be performed by randomly choosing one of the selected products.

In another implementation, the combination technique includes, for each measurable attribute, associating a fraction value with each of the selected products such that the sum of the fraction values totals 1, multiplying the attribute value of each of the selected products by the fraction value associated with that product, and taking the sum of the results of the multiplying step as the progeny attribute value for that measurable attribute. In another implementation, the combination technique includes associating a fraction value with each of the selected products such that the fraction values total 1. For each of a subset of measurable attributes, the attribute value of each of the selected products is multiplied by the fraction value associated with that product. The sum of the results of the multiplication operations is taken as the progeny attribute value for that measurable attribute. The subset of measurable attributes can range from just one of the measurable attributes to all of the measurable attributes. Also, the association can include associating at least one random fraction value with one of the selected products.

At least one candidate product is selected based on the progeny attribute values. The selection can be performed based on proximity of candidate product attribute values to progeny attribute values.

The method can also include identifying the attributes that are important to a user by observing user selection, including for example past selection, current selection, or both, and selecting at least one candidate product based on the progeny attribute values and the attributes that are important to the user.

At least one candidate product is presented to the user. This can include presenting information about the product, including the product attributes. In one embodiment, this presentation is accomplished by presenting one or more candidate products to the user by transmitting information describing the one or more candidate products from the server computer over the computer network to the client computer for communication to the user by the client computer. In one embodiment, the server computer comprises a web server, the client computer comprises a web browser, and the computer network comprises the Internet.

In another aspect, the invention relates to a system that performs these method steps. One such system includes a user interface for facilitating user selection of one or more products, a combination subsystem for combining the attribute values, a selection subsystem for selecting one or more candidate products, and a result output for communicating the one or more candidate products to the user. In one embodiment, these system elements are each functional modules originating with and/or running on a server computer, with the interface being communicated to a client computer (e.g., as a web page) for display. In other embodiments, the system elements are implemented on a single computer, (e.g. a personal computer (PC), laptop, personal digital assistant, etc.), for example, in a user's home, office, or in the form of a kiosk at a retail location.

The foregoing and other objects, aspects, features, and advantages of the invention will become more apparent from the following description and from the claims.

### BRIEF DESCRIPTION OF THE DRAWINGS

in the drawings, like reference characters generally refer to the same parts throughout the different views. Also, the drawings are not necessarily to scale, emphasis instead generally being placed upon illustrating the principles of the invention.

FIG. 1 is a flowchart depicting an embodiment of a method according to the invention.

FIG. 2 is a schematic of a system in an embodiment of the invention.

FIG. 3 is a screen display in an example of operation of an embodiment of the invention.

FIG. 4 is another screen display in the example of FIG. 3.

FIG. 5 is another screen display in the example of FIG. 3.

FIG. 6 is another screen display in the example of FIG. 3.

### DETAILED DESCRIPTION

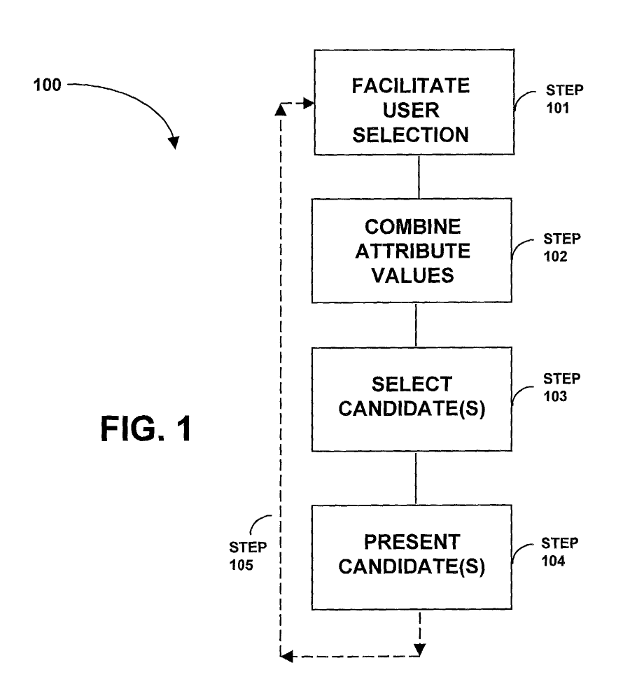

Referring to FIG. 1, an embodiment of a method 100 according to the invention helps a user search for a product from among a number of products in a product space. There can be any number of products to choose from in the product space, and some of the products may be similar or different from each other.

The user can be a consumer, a business customer, or any other person or entity who is using or communicating with product broker system, directly, in-person, over a computer network (such as the Jnternet), via an intermediary such as a salesperson, via another computer-based system, or otherwise, to facilitate product selection. The user may search for a product that is optimal, i.e. that is the best available product for that user. The user may determine that a product is satisfactory or sufficient, even if it is not literally the most optimal product for the user—the term optimal as used here includes such a satisfactory or sufficient product.

A product can be any sort of good, service, item, or entity that can be described by a computer-based system. Products may be sold by a product broker that is incorporated into an electronic commerce system, or alternatively aspects of the invention may be used to facilitate selection, with product purchase or assignment accomplished by some other means. Such goods and services include, as illustrative examples without limitation, consumer goods as varied as clothing, vehicles, and furniture; consumer services as varied as housecleaning, computer consulting, insurance, and medical services, business goods as varied as industrial chemicals, enterprise network equipment, and office supplies, and business services, as varied as copying services, consulting services, and accounting services. These examples, and the type or characteristics of other example products described m this application are not intended to be limitations on the invention, rather, all items, goods and services are intended to be included in the term product.

A product can, in fact, be anything that can be bartered, sold, traded, or selected. For example, “products,” in one embodiment, include people participating in a dating service; in effect, the product is a service offered by the participants—a date with themselves. The product space is populated with eligible bachelors and bachelorettes, each with attributes representing their education and physical characteristics such as the color of their eyes, shape of their noses, and so on. Here, learning about the product space means that users ascertain their own preferences for what they find attractive in others. Thus, in addition to demonstrating the variety of products with which aspects of the invention may be used, the use of the product broker as a dating broker demonstrates how the invention assists users in learning about their own preferences.

Products are defined by a set of measurable attributes, and each product preferably has a value for each relevant attribute. The measurable attributes may be measured precisely, e.g. by measuring the length of a product, or identifying a number of months of a service. A measurable attribute also can be measured less precisely, e.g. by a determination that a book is mostly a comedy, measured as a seven on a scale from one to ten. To be clear, it is not a requirement that a measurable attribute actually be measurable by a tool or device but rather that a value can be assigned to that attribute for at least one product. For some products, deducing attribute values may not be trivial. For example, with shoes, personal judgment determines their comfort level. Measurements may be made by an impartial third party, such as Consumer Reports, or by using surveys or otherwise aggregating multiple opinions.

Values that are assigned to attributes can be any of integral numbers, real numbers, boolean values, string values, and so on. It may even be the case that an attribute that is associated with a book is not appropriate for a refrigerator, and so a not applicable (NA) value or other such values may be assigned to measurable attributes. The values of the measurable attributes are not intended to be a limitation, so that measurable attributes can have any sort of values that are appropriate in a particular implementation. Attributes can be grouped in sets that are provisionally provided with a product so that, for example, if a product has a measurable attribute PRODUCT TYPE having a value of BOOK, other book-related measurable attributes will be associated with that product.

In one embodiment, each attribute is assigned an integral value. It may be helpful in such an embodiment to provide an explanation to users if attribute values are displayed. For example, instead of just showing a cost attribute value of 7, to also show an explanation of “High Cost: Range $70-$100.” It should be noted that users may not respond well to being presented only with a one-to-ten scale of product attribute values. As a result, mapping from these integers to real-world explanations results in an improvement to the user's understanding of the product space, and how products fit within that space.

The method includes facilitating user selection of one or more products (STEP 101). One or more products, often several products, are presented to a user. In the first iteration of the method, a random or predetermined selection of products from the product space can be presented to the user. This selection can be made randomly, from a predetermined starting pattern that has a representative sampling of the product space, or some combination. In a web-based system, products are presented on a web page for the user to choose from, and after displaying the choices, the system waits for identification of the user's selection. The system may present graphical depictions, such as drawings or photographs, of the products, so that they are displayed visually for selection. The system may present logos or other graphics or pictures associated with the source of the product, or product packaging. The system may present information about the products, including the specifications and features of the products. In a product showroom, the system may switch on a light illuminating the product, for example, or otherwise make the actual products available for inspection, and provide a mechanism for easy user selection of products.

The user may, upon presentation of some number of products, identify one product as a desired product. This may be the case, in particular, if the set of products that is presented to the user follows more than one iteration of this method. If so, the method can include the step of providing further details about the desired product. The method can include the step of facilitating user purchase of the selected product. The method can also use the selection by the user to identify other products that are similar to the one selected product, to verify that the selected product is the user's best choice.

The user may, upon being presented with some number of products, select one or more products. The selection of products by the user can indicate that the user likes or prefers one or more attributes of a product. The selection of a product might also, however, indicate that the product has one or more attributes that are disliked or disfavored. An embodiment of the invention can allow for either type of selection (like or dislike), or both. In one implementation, for example, the user selects a product with a click of the left mouse button on a graphical depiction of the product if the product is desired, and selects a product with a click of the left mouse button on a graphical depiction of the product while holding down the shift key on the keyboard if the product is disliked. In another embodiment, a disliked product is indicted by a click of the right mouse button on a graphical depiction of the disliked product.

With continued reference to FIG. 1, the method includes the step of combining the attribute values of the selected products to produce a set of progeny attribute values (STEP 102). Various combination methods can be used to combine the attribute values of the selected products to produce progeny attribute values. Combination techniques can take into account both favored and disfavored selected products, and can include combining attribute values in an averaging or a weighted averaging manner, and may also include choosing some attribute values from one selected product and other attribute values from another selected product. Combination techniques that include combining attribute values from disfavored products can include weighting, or reversing some or all of the attribute values of the disfavored product.

In one embodiment, the combination technique includes a random probability function, so, for example, the attribute values to be used in the combination are selected randomly, or, as another example, varied in a random manner. In one embodiment, the combination technique includes, for each measurable attribute, choosing one of the selected products, and taking the attribute value of one of the selected products as the progeny attribute value for that measurable attribute. In another embodiment, the combination technique includes choosing one of the selected products and, for a subset (which may be all) of the measurable attributes, taking the attribute value of the chosen one of the selected products as the progeny attribute value for that measurable attribute. The selected product may be chosen randomly, or by some other technique. In one embodiment, a first selected product is chosen randomly for taking a first subset, and other subsets are taken from each of the selected products in a predetermined order.

In another embodiment, the combination includes, for each measurable attribute, associating a fraction value with each of the selected products such that the fraction values total 1, multiplying the attribute value of each of the selected products by the fraction value associated with that product, and taking the sum of the results of the multiplying step as the progeny attribute value for that measurable attribute. In another embodiment, the combination technique includes associating a fraction value with each of the selected products such that the fraction values total 1, and for each of a subset of measurable attributes (which may include all of the measurable attributes), multiplying the attribute value of each of the selected products by the fraction value associated with that product, and taking the sum of the results of the multiplying step as the progeny attribute value for that measurable attribute. Associating a fraction value may be accomplished by associating at least one random fraction value with one of the selected products.

TABLE 1
EXAMPLE

| | | | | | Mean |
|---|---|---|---|---|---|
| | A1 | A2 | A3 | Deviation | Deviation |
| P1 | 9 | 10 | 10 | 1 + 7 + 0 = 8 | 8/3 |
| P2 | 10 | 3 | 5 | 0 + 0 + 5 = 5 | 5/3 |
| P3 | 7 | 7 | 10 | 3 + 4 + 0 = 7 | 7/3 |
| P4 | 4 | 3 | 3 | 6 + 0 + 7 = 13 | 13/3 |
| P5 | 6 | 9 | 3 | 4 + 6 + 7 = 17 | 17/3 |
| P6 | 10 | 2 | 9 | 0 + 1 + 1 = 2 | 2/3 |
| COMB. | 10 | 3 | 10 | — | — |
| P1-P2 | | | | | |

Referring to TABLE 1, an example simplified for explanation, six products P1-P6 each have three attributes A1-A3, which each have a value range from 1-10. If the user selects products P1 and P2 as the closest choices, the attributes of products P1 and P2 are merged. In this example, the combination function will, for each attribute, randomly choose one of the products, and take the attribute for that product as the progeny attribute value. For the first attribute A1, product P2 is randomly chosen, and so the progeny of the combination, shown in the table as COMB. P1+P2, has a value of 10 for attribute A1. For the second attribute A2, product P2 is randomly chosen, and so the progeny has a value of 3 for the second attribute A2. For the third attribute A3, product P1 is randomly chosen, and so the progeny's third attribute has a value of 10 for the third attribute A3. Thus the combination technique includes a random probability function, which is used to randomly choose one of the selected products.

The combination function may, optionally, also introduce a random alternation of the progeny attributes. Introducing a random alteration can help the user explore the product space. In one embodiment, the system always performs some random alteration of the progeny attribute values. In another embodiment, the system performs some random alteration of the progeny attribute values when it has determined that the user is exploring the product space, rather than trying to identify a specific product.

The progeny attribute values can then be used to identify at least one candidate product (STEP 103). Products with attribute values that are close to the progeny attribute values are identified. Once a progeny or “hypothetical” desired product is generated using the combination technique, the hypothetical product needs to be matched to actual products, so that a sampling of products can be presented to the user. This can be done in various ways. For example, a least mean deviation can be used to determine the closest one or more candidate products.

Again, using the example of TABLE 1 for demonstrative purposes, the mean deviation can be calculated for each of the products P1-P6. The total deviation is shown in the table as the sum of the differences between each attribute value and the progeny attribute value. The mean deviation is the total deviation divided by the number of attributes, which in this case is three attributes. As shown in the table, the mean deviation for product P1 is 8/3, for product P2 is 5/3, for product P3 is 7/3, for product P4 is 13/3, for product P5 is 17/3, and for product P6 is ⅔. In order of least mean deviation, the closest products to the progeny product are: P6, P2, P3, P1, P4, and P5. In this example, product P6 is the closest, by least mean deviation, to the progeny product. In actual implementations, other methods, including more sophisticated statistical deviations, can be used to select the candidate products in addition to or instead of the least mean deviation just shown.

A weighted least mean deviation can be used to emphasize attribute values that the system has identified as being important to the user. As described further below, as the system observes the user's choices, the system can identify the attributes that are important to the user. Attributes that are important to the user can be weighted more heavily in the determination of the deviation, while less important attributes can be weighted less heavily. This allows for less variance in the attributes that are important to the user, and more variance for the attributes that are less important.

The at least one selected candidate product is presented to the user (STEP 104). In a web-based system, this can be accomplished by displaying the one or more results to the user as a web page. The number of results can be determined by the number of candidate products that are close to the progeny attribute values. The number of results also can be determined by an indicated user preference. If more than two candidate products are presented to the user, the method can be repeated in an iterative manner so that the user can (as in STEP 100 above) select from the presented candidate products. The steps can be repeated (STEP 105) until a satisfactory product is selected.

It should be noted that the communication between the user and the system can take place in real-time, or in staggered or delayed communication sessions, such as by electronic mail or by mail or messenger. The communication can include screen displays and graphical representations and product description, but can also include audio descriptions (for example if implemented over a telephone network) or by interactive audio and video, such as by live communications or by video conference technology. In one embodiment, the method could be incorporated into a robotic sales system brokering items to a user, or a kiosk or other display presented to patrons at a retail location.

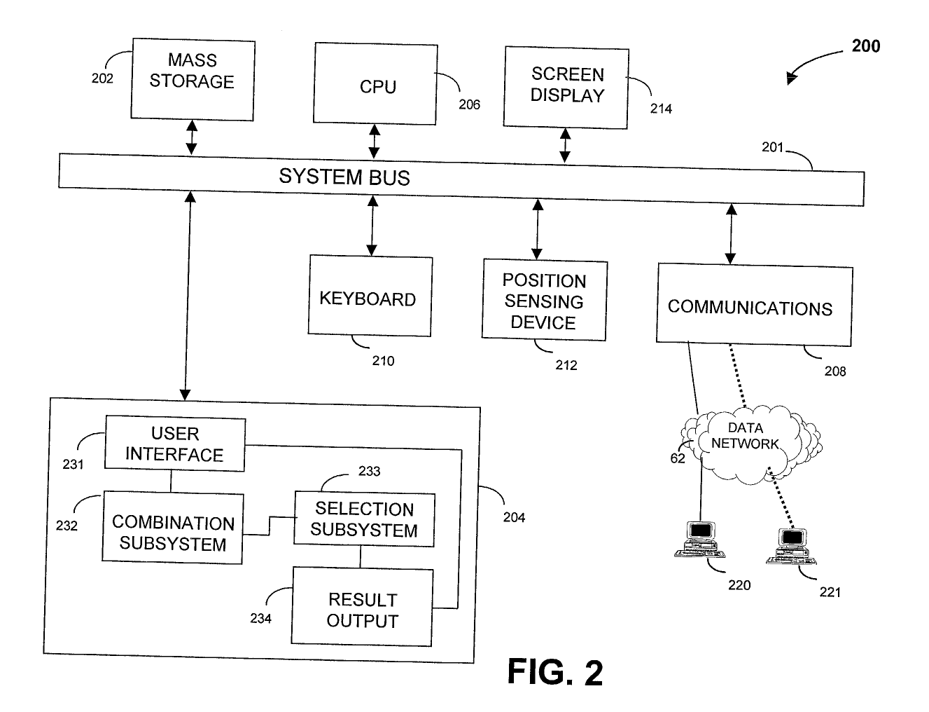

Referring to FIG. 2, one embodiment of a system 200 according to the present invention is implemented as a general purpose computer, such as a personal computer or server computer having a typical general purpose computer architecture. In an over-the-web embodiment, the system 200 is a web server that communicates with web clients 220, 221 over the Internet. The user interacts with web clients 220, 221, which in turn communicates with the system 200 on the user's behalf. In another embodiment, the user communicates directly with the system using the keyboard 210 and position sensing device 212 as input devices, and using the screen display 214 as an output device. In this embodiment, the system 200 might be the user's computer, after loading instructions and data from a CD-ROM provided by a product vendor. The system 200 might also be installed in a retail location, as an automatic product selection tool.

The system 200 includes a main bidirectional bus 201, over which all system components communicate. These system components may be connected directly to the bus 201 as shown, or they may be connected through a serial port, USB port, parallel port, and so on. The main sequence of instructions effectuating the functions of the invention and facilitating interaction among the user and the system reside on a mass storage device (such as a hard disk, floppy disk, or optical storage unit) 202 as well as in a main system memory 204 during operation. Execution of these instructions and performance of the functions of the invention is accomplished by a central-processing unit (“CPU”) 206, which may be a processor such as with Intel Pentium, Motorola PowerPC, or Sun SPARC. A communications interface 208 is a telephone modem or network controller that connects, via a gateway or an Internet access provider, to a data network 222. The data network 222 can be an intranet, a private network, or it can be the Internet, or some combination. As a result, the system can be a node on a network 222 such as the Internet. A system operator, who may or may not be the user of the product broker, can interact with the system 200 using a keyboard 210 and a position-sensing device (e.g., a mouse) 212. Either device 210, 212 can be used to designate information used to operate the system.

The main memory 204 contains a group of modules that control operation of the CPU 206 and its interaction with the other hardware components. An operating system (not shown) directs the execution of low-level, basic system functions such as memory allocation, file management, and operation of mass storage device(s) 202.

At a higher level, a user interface module 231, implemented as a series of stored instructions, facilitates user selection of one or more products. In an Internet web-based embodiment, the user interface 231 communicates code (e.g. HTML instructions) and graphical data via the communications interface 208 and over the Internet 222 to a client computer 220, 221. The code and graphical data are received by the user's web browser, and the web page that is displayed facilitates user selection of products. The user's selection of products causes the user's web browser running on the client computer 220, 221 to communicate the selection information back to the system 200. In a direct access embodiment, the user interface 231 generates data for the screen display 214 that facilitates user selection of products via the keyboard 210 and the position sensing device 212.

In one embodiment, the user interface module 231 provides a simple display that allows users to easily navigate a multidimensional product space. The interface is designed to be so simple that it does not require an instruction manual. The display allows the user to examine products right away, with no instructions or questionnaires. The interface is primarily visual, allowing for direct manipulation by the user, allowing the user to jump straight into the product space and providing useful feedback. A visual, directly manipulated interface allows for effective navigation and search of the product space. The user can navigate the product space quickly, and see the results immediately. Language and ontology issues are eliminated. Finally, keeping the interface visual retains many pleasurable aspects of browsing a store or mall.

The user interface desirably provides an overview first, allows zoom and filter, provides details on demand and useful feedback. The overview is provided by the user interface starting as a browsing experience with no initial assumptions on the user. Zooming and filtering facilitates user control over the navigation of the product space. To provide details on demand, user interface 231 supplies additional product information if requested. Feedback is preferably provided for fast visualization and effective user response. Each interaction should provide feedback to indicate that the interaction has been noted. Similarly, the user should be able to determine the system's state with a quick glance.

A comparative interface is preferably used to assist user navigation. The ability to compare different products to one another is helpful because some users prefer not to analyze in isolation. By examining the local detail of a product with the global context, a user gains a better understanding of the product.

A user selects a product by clicking on it, a natural behavior to indicate interest. For feedback, the user interface may lighten the product's image. Indication of a strong negative product response is also a simple process: the user can either hold down a predetermined keyboard key (e.g. alt, control, shift) and click on the product with the mouse, or (in addition or instead) the user can select the product and press delete. In other embodiments, the user can indicate positive or negative preferences by clicking on buttons under the products or using menu items. Buttons and menu items can be appropriately marked by the works “like” and “dislike,” a “thumbs-up” or “thumbs-down” symbol, or the like. Feedback for the indication of negative preference is shown by displaying an X through the deleted product.

Users learn about a product by explicitly requesting additional information. In one embodiment, the information is presented upon clicking on the product with the right mouse button. In other embodiments, this can be performed by the user clicking on a button or menu item marked by such words as “more information” or something similar, a question mark symbol, and so on. The information may include the attributes and attribute values for the product, as well as other information about the product. By examining this additional information, the user learns about the product space. She discovers which attributes make up the space, and how this particular product is located in the product space.

The user interface may show the attribute visually by expressing each attribute's domain by a line drawn as a scrollbar. The scrollbar position expresses the attribute value. The user can intuitively and directly edit the attribute value by moving the scrollbar. As the user becomes more familiar with the product space, the user can direct navigation by modifying product attribute values. For example, a user may like a convertible such as a Mazda Miata, but want something a little larger. When she requests display of the Miata's attributes values, she can edit the size attribute to indicate her preference that future product selections will be like the Miata but larger.

Visual feedback can be used to indicate which attributes have been modified. In one embodiment, a label listing the edited attributes is placed above a picture of the product. Thus, the product image remains the same, with an identifiable tag indicating that attributes have been modified.

The user interface also may allow users to return to a previously displayed group of products and observe what would have happened if the user had made a different decision. In one embodiment, history buttons, such as those found on web browsers, are employed. Users can navigate using “back” and “forward” buttons to represent moving forward and backward through iterations of the selection process. As described below, a modified genetic algorithim can be used in an embodiment of the invention that involves iterations of selections.

An important balance in the design of a user interface is the tension between designing for ease-of-use versus for direct manipulation and control by the user. To facilitate ease-of-use, work can be offloaded from the user; however, this also lessens the user's control. This automation-control tradeoff is inherent in any shopping decision support system, because a typical user desires a high level of control of a shopping application, yet the same user also desires ease-of-use. This balance may be addressed in an embodiment of the present invention by level structuring such that a naive user would not be distracted by complicated features, yet an advanced user can easily get to the tools he needs. Ease-of-use is preferably the default, and advanced features are optional and are available if explicitly requested.

As another example of the balance between automation and control, an embodiment of the invention automatically combines the attribute values after a second product is selected. In such an embodiment, only two products can be selected. Automatic combination may distract or annoy the user because it usurps authority to navigate. Thus, in another embodiment, the user explicitly indicates that product selection is complete, for example by clicking on a button. A1though this places the requirement of additional work on the user, this design decision can give the user the perception of greater control over the interaction.

Another issue is how much product information to display, and whether it is better to have more tools or a less cluttered interface. In one embodiment, product traits are described underneath the product's image. This gives the user more information than just the visual representation. This information may be distracting, however, particularly for users who do not care or do not understand certain attributes. When browsing though a store, people walk down an aisle visually inspecting the merchandise. Only when they find a product they wish to examine further do they pick it up and ascertain its attributes carefully.

In another embodiment, the behavior of the user interface allows a user interested in learning about the underlying product space to do so by explicitly requesting more information by, for example, clicking on the product with the right mouse button. Thus, the user can quickly scan through a space visually, and when the user wants more information, the user can “pick up the product and examine it” with a right-click of the mouse. Hiding the attribute information until it is requested augments ease-of-use and navigation speed, as potentially distracting visual clutter is not shown. Users who do not care about the underlying attributes are not burdened with excess information. A1so, cognitive overhead is reduced because product attribute information is quantitative and the image is qualitative and so the user does not have to handle two separate modes of comparison simultaneously. Not showing the attributes on the primary screen also solves a scalability issue. As products are described by more attributes, it becomes increasingly difficult to visually depict many attributes in a limited space.

Another user interface design issue is the balance between consistency and functionality. Consistency of interface is important. While abusing notation or combining two modes of operation has functional advantages, doing so often breaks the interface's consistency. As one example, editing product attribute values by moving a scroll bar adds a second mode of operation in addition to the selection of products to be combined. In one embodiment, the user can select one product whose attributes have been modified and see products like the modified product. While this provides good functionality, it is inconsistent with the mating procedure in which the user selects two products. To ensure a consistent interface, in another embodiment, the user is required to select a second product with which to combine a product with the modified attributes. While this may not be as functional nor easy-to-use, it maintains a consistent interface.

A second example of a consistency functionality balance is whether to allow more or less than two products to be combined. In one embodiment, the user can select any number of products with which to perform the combination. In another embodiment, the number of products that can be selected is limited to two. While being limited to two products may not be as functional as an open number, it provides a consistent interface and a clearer definition of mating.

In an embodiment which limits combination to two products, visual and aural cues can be used to help the user understand the two-product limitation. The combination initiation interface (e.g. a button labeled “New Selections,” “Refresh,” or “Next”) is disabled until the user selects two products. The system beeps if the user attempts to select more than two products.

Still referring to FIG. 2, product combination is performed by a combination subsystem 232, also implemented as a series of stored instructions. Subsystem 232 combines attribute values of the selected products in accordance with a combination technique to produce a set of progeny attribute values, which are used to guide further product selection and exploration. An embodiment of the invention thus uses a modified genetic or evolutionary algorithm. A genetic or evolutionary algorithm starts with an initial population of individuals, each with an underlying genome representing its characteristics. A fitness function takes an individual's genotype and returns a value representing its goodness. This function is applied to all individuals in the population, and the fittest are selected to reproduce. Mating combines the genetic traits of the selected individuals to produce offspring. The less-fit individuals are replaced with offspring by a replacement policy.

Genetic algorithms generally are used to generate new individuals. Here, a modified genetic algorithm is used as part of an embodiment of the invention to select one or more existing products, not to create a new product. This can alternatively be thought of as a mapping of the product's genotype, or genetic material, to a phenotype, or physical appearance. Thus, instead of evolving new products, an embodiment of the invention selects from existing products, thus utilizing a genetic algorithm modified for selection rather than evolution. A1so, an embodiment of the invention has the added feature of allowing for selection of disliked or disfavored genetic traits.

Genetic algorithms generally have good multidimensional search characteristics. As they mate the more “fit” individuals, the algorithm proceeds towards a solution by exploitation, or hill-climbing. One weakness with just hill-climbing is that is possible to get stuck at a local maximum; in other words, it is possible that the hill being climbed is not the largest on a global perspective. As such, good search techniques allow for exploration, which is the ability to visit other possible hills. Genetic algorithms can provide exploration through mutation of the offspring's genome. If they provide good exploitation and exploration characteristics, genetic algorithms can quickly converge on an optimal solution.

In the present application, the underlying genome consists of a product's attributes. For example, a car's genome includes such attributes as fuel economy and safety rating. These ratings are converted into a value, which is one embodiment is an integral representation. Instead of a pre-specified fitness function, an embodiment of the invention allows the user to specify which individuals are desirable. The selection function is the individual(s) the user selects. Any suitable mating technique or function can be used, for example, techniques described in I(arl Sims, Artificial Evolution for Computer Graphics, Computer Graphics 25(4),Jul. 1991, pp. 319-328 (hereby incorporated by reference).

In one embodiment, the selected products' traits are combined such that, for every product attribute, an offspring's value comes from one of the parents. In one embodiment with two parents, for example, the attribute value of each offspring is selected with a fifty percent chance. Additionally, mutations cause occasional genes to be set to a random value in the attribute domain.

In one embodiment, mutations occur at random at a predetermined probability for the various attributes. Deterrmning the proper mutation probability and the mutant gene's value is performed by trial and error for different product spaces. In one embodiment, the mutation probability is a fixed number for all attributes and all users. In another embodiment, this factor is tailored to the individual based on the relative amounts of exploration and exploitation she prefers. For example, a user who enjoys more serendipity is assigned a higher mutation factor, while a more focused user has a lower mutation probability. If the user has explored serendipitous (seemingly unrelated) products in the past, she is likely to enjoy more exploration in the future. In yet another embodiment, the mutation factor differs for each attribute. More important attributes vary less, as the user cares more that they fall within a certain range. However, less important traits have a higher mutation probability as this considers a more accurate subspace.

The simplest combination randomly takes an attribute value from either of the patents to determine the child's attribute value. This is the technique shown in the example of TABLE 1 above. This combination strategy can provide good mixing of the parent's attributes.

A second combination strategy involves weighting the parents' genes. A random percentage of one parent's gene is combined with one minus the percentage of the other parent's gene. Linear interpolation (averaging) occurs when this probability is set to 1/n, where n is the number of patents. While this is a valid mating strategy, it may provide poor results because it does not semantically map to mating products. If a user selects a sports car and a rinivan, she is likely interested in a cat with the speed of the sports car and the size of the minivan. However, linear interpolation produces cars with mediocre sports and size characteristics. Additionally, all offspring occur on a line equidistant between the patents. Another problem with this strategy is that upon iteration, the user ends up in the middle of the product space, even if the user is not picking at random. The simpler combination technique (that does not average the selected attribute values) can therefore provide better results.

A third strategy is similar to the weighting strategy; however, the weight is established separately for each gene. This has problems similar to those of the weighting strategy, though the results will likely have more attribute value diversity.

A fourth strategy copies attribute values first from one parent, and then (randomly or in a predetermined matter) switches to another parent, and then (randomly or in a predetermined matter) to another (or back to the first), and so on. This strategy can keep related attribute values together. In biology, for example, if the genes for a hand and those to control the hand neighbor on the genome, they will likely stay together in the offspring. To make this strategy most effective, it may be helpful to determine a relationship between attributes, and copy related attributes together.

In one embodiment, all products are replaced by a new group of possible product selections, (possibly including the products just selected). A traditional genetic algorithm would be complete once it results in an evolved population of children, however, since the purpose of this algorithm is not to create new products, but to navigate existing ones, an additional subsystem is used.

Still referring to FIG. 2, a selection subsystem 233, also implemented as a series of stored instructions, selects from among the products at least one candidate product based on the progeny attribute values. The selection subsystem 233 maps newly created product offspring back to existing products. It uses a least mean deviation, or other linear distance metric to map the new offspring to the one or more products nearest it in the product space. Another embodiment uses a quadratic distance metric. With the quadratic metric, it can be difficult to prevent an unimportant attribute from skewing the results. A weighted quadratic metric that is weighted more heavily toward important attributes may provide improved results.

In addition to the distance metric, to adapt to the user's changing search specification, an embodiment of the selection subsystem 233 learns about the user. By observing the user's interactions and decisions, the program develops a model of the user and her preferences. A model gathered from observation provides information about the user's desires without explicit user instruction by the user. This information can be used to educate the user about the product space. This information can also be used to identify the attributes that are important to a user, by examining the variability in the attributes of desired products, and to determine whether the user is exploring the product space or narrowing down on a particular desired product.

The selection subsystem 233 endeavors to ascertain the user's ideal combination of product traits. In other words, the selection subsystem 233 attempts to determine the user's utility function, which is a measure of the user's desires. By observing the user's decisions, the selection subsystem 233 develops a map of the user's multi-dimensional utility function in a process akin to Multi-Attribute Utility Theory.

By examling the user's history, an embodiment of the selection subsystem 233 can use a statistical pattern recognition metric to identify important attributes and develop a user model. The embodiment detects two types of user preferences, an exact preference and a one-sided preference. An example of an exact preference is a user desiring a car with enough room for five people. The user might find a car with room for four or six people acceptable, but definitely not three or seven. This preference is modeled by a Gaussian random variable. The embodiment identifies the mean and variance of this variable's distribution. If the attribute's values follow this pattern, the system deduces an exact preference on this attribute's value. The determining criterion is if the variable's sample variance falls below a threshold.

A one-sided preference is an upper or lower bound on an attribute value. For example, the user may have an upper price point on how much he can spend. As long as the product is less expensive than this value, he will consider other attributes. An example of a lower bound may be a minimum comfort level on a shoe required by the consumer. One-sided preferences are more difficult to detect, as they do not follow the symmnetric Gaussian bell-shaped curve. The embodiment examines the minimum and maximum values for this attribute. If either is significantly different than the mnitnium and maximum of the attribute value domain, the system concludes that this preference is one-sided.

In another embodiment, the user can explicitly identify one-sided or two sided bounds for one or more attribute values. For example, the user could explicitly specify that cost of a vehicle may not be greater than $20,000 (one-sided), or as another example, explicitly specify that the passenger capacity be greater than four passengers and less than seven passengers (two sided). These explicit bounds can be used to weed out possible product choices. They can also be used to identify other preferences that might be important to the user.

Revealed preferences also assist an embodiment of the selection subsystem 233 in developing a user model. If a user has a choice between two products, the chosen product is revealed to be preferred to the other. If chosen products likely have certain characteristics in common that the other members of the population do not possess, those attributes are identified, since the user has, in effect, implied a preference for these differences. In practice, the population is not a random sampling, but chosen to have similar traits by the modified genetic algorithm, and as a result there is less heterogeneity and difference between products. If a significant difference is found, it is used.

Another avenue of learning is an explicit negative preference. Crossing-out (i.e., negative selection of) a product has two semantically plausible meanings. The user may not like the specific product, even if she likes its underlying attributes, or the user does not like the product because of its underlying attributes. The selection subsystem 233 detects which of these meanings is intended through revealed preference. Specifically, if the crossed-out product has attributes similar to the selected products, the user likes the attributes but does not like the individual product. For example, the user may be presented with a choice between a Chevrolet Corvette, a Chevrolet Camaro, and a Pontiac Firebird. These three cars have a similar engine and other attributes. However, if the user expresses dislike for the Corvette, the user just dislikes the Corvette, not its attributes. As their attributes are all simnilar, it is unlikely that the user quantitatively dislikes the Corvette, rather she qualitatively dislikes the individual product. On the other hand, if the user had to choose between the Chevrolet Camaro, the Pontiac Firebird, and a minivan, and indicated a negative preference for the minivan, it is likely that the user does not like the minivan's underlying attributes. The minivan's quantitative attributes significantly differ from those of the other choices, so it is both qualitatively and quantitatively selected against.

An embodiment of the selection subsystem 233 can also determine how close the user is to finding a product, which indicates whether the user is primarily browsing or searching. To detect if a user is searching more than browsing, the embodiment determines whether the user's current and historic product choices are similar in some attributes. If the user has little specification, in other words is still browsing, the user will want more diverse choices. A user who is close to finding a product (i.e., searching) may want a narrower selection of choices. In one embodiment, to provide more infornation, if the user is searching, the values of the most important traits are depicted below the product. Although this might not be as consistent from a user interface point of view, and involves presentation of quantitative and qualitative information simultaneously, searching users are more likely to spend time looking as they get closer to making a decision. Here, ease-of-use could be enhanced by offering information the searching user is likely to request.

The selection subsystem 233 may be configured to detect how close the user is to searching. This can be performed by taking a weighted average of the attribute differences, with the weights measuring the attributes' importance. However, if a variance metric is used both for ascertaining attribute importance and also for the attribute's variance, there is one degree of freedom too few. Also, the metric ideally should be independent of number of products in the user's history, and the number of attributes. Additionally, the metric ideally should emphasize recent product choices as they are generally of greater importance than choices in a user's past. Of course, metrics that are less than ideal may still be useful.

In one embodiment, once the selection subsystem 233 determines that the user is searching, domain-specific questions are used by a questioning subsystem (not shown) to provide personalization, further engendering an environment of trust and user model accuracy. By possessing specific domain and user information, the system can ask the user specific questions to further refine its user model. For example, the selection subsystem 233 may not be aware of the user's maximum price point. By explicitly asking the user, the questioning subsystem resolves this ambiguity. Since these questions are directly related to the user and her search, she will be more likely to answer. Also, just by observing that the questions asked are specific, the consumer sees that the overall system is personalizing itself to the user. This engenders further trust, and this additional information can be used to identify products that would be appealing to the user.

In general, an embodiment of the invention may work well in detecting the user's preferences, but may become “confused” when a user breaks from a consistent pattern. The selection subsystem 233 therefore also attempts to recognize whether the user is just experimenting and haphazardly trying a choice that is different from the previous direction, or if the user has made a context switch.

Another issue involves detection of preferences that are not intended. For example, sports cars have high speed at the expense of low fuel economy. If a user selects several sports cars, the selection subsystem 233 may deduce that the user wants high speed and low fuel economy. The low fuel economy is an undesired by-product of the negative relationship between the two variables. In may be difficult for a designer to predict the desired direction of each attribute because certain users may want different values for an attribute, so another option is to include domain-specific rules representing these relationships. The selection subsystem 233 could then use such rules to distinguish real preferences from unintended by-products.

In one embodiment, the user interface 231 exposes an editable user model so the user can correct erroneous or by-product inferences. The user interface thus delineates the product's attributes and the user gains control. Since the user interface exposes the user model and provides explanations, the user can verify that recommended products have attributes in common with those selected. Thus, the system proves the objectivity of its exploitation behavior.

For example, user interface 231 may provide explanations that allow the user to ascertain why she is looking at a set of products. Perhaps the selection subsystem 233 has erroneously deduced that the user wants a big car, when in fact the user wants a smaller sedan. By accessing the profile, the user interface can detect why she is being presented with strange and undesired product choices. She can then edit her user model to prevent further errant product selection.

Still referring to FIG. 2, a result output module 234 communicates the at least one candidate product to the user. In an over-the-web embodiment, the result output 234 communicates code (e.g. HTML instructions) and graphical data via the communications interface 208 over the Internet 222 to a client computer 220, 221. The code and graphical data are received by the user's web browser, and the web page that is displayed communicates the at least one candidate product to the user. In a direct access embodiment, the result output 234 generates text and graphical data for the screen display 214 that communicates the at least one candidate product to the user.

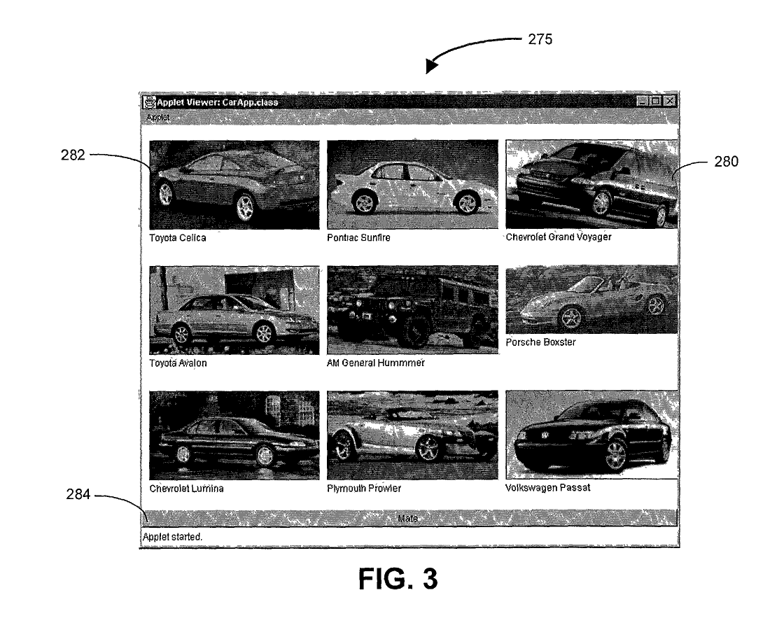

Referring to FIG. 3, an example of the use of an internet-based embodiment of the invention is now described. The example is based on a user, Beth, who is an accountant earning $80,000 a year, and who is in the market for a new car. Beth has two pre-teenage children and expects to purchase a minivan to transport her kids from school to soccer practice. However, ever since she was a child, she dreamed of owning a car like her father's Ford Mustang.

Beth wants to find her dream car, however, her criteria are fuzzy and she has preferences, not hard constraints. She would not know what to type into a search engine nor does she want to browse through every car in a catalog. Beth can specify what she wants only in fuzzy terms that a salesman might understand, but a search engine would not. Using the embodiment of this example, Beth is able to find a vehicle that satisfies her needs.

In this example, the products from which Beth chooses are automobiles, and the product space for this example is all available vehicles. In another example, the set of possible products might be limited to, for example, the automobiles available from a certain car dealer or manufacturer, or a group of dealers or manufacturers.

As shown in the figure, initially upon accessing the user interface, Beth sees what appears to be, and in fact is, a random sampling 275 of the available products. Beth is instructed to select one or more products that she likes. Beth eyes the minivan 280, and sees herself driving her son Timmy's soccer team in it. She selects it. Her attention is then drawn to the upper-left corner, to the sporty Toyota Celica 282. She likes it and so she selects it as well. Beth then clicks on the new selection initiation button 284 to see additional cars.

Clicking on the new selection initiation button directs operation of the combination and selection subsystems, described above, to identify a new set of product choices for Beth to choose from. In this example, the combination of the attribute values of the two selected products is performed upon Beth's clicking on the selection initiation button 284. The combination is performed by randomly choosing one of the selected products, and, for a predetermined number (e.g. two) of the measurable attributes (i.e. a subset of the measurable attributes), taking the attribute values of the chosen one of the selected products as the progeny attribute values for the subset. If necessary, depending on the predetermined number and the total number of attribute values, additional random choice from the selected products is performed, and additional subset(s) of the measurable attributes values taken a progeny attribute values, until a complete set of progeny attribute values is produced.

Next, a group of products is selected from the plurality of products, based on the progeny attribute values. In this example, the products presented are those that have the least mean deviation from the progeny attributes. Note that this example uses a simple combination and selection process, and that the more complex processes described above could be used in addition or instead.

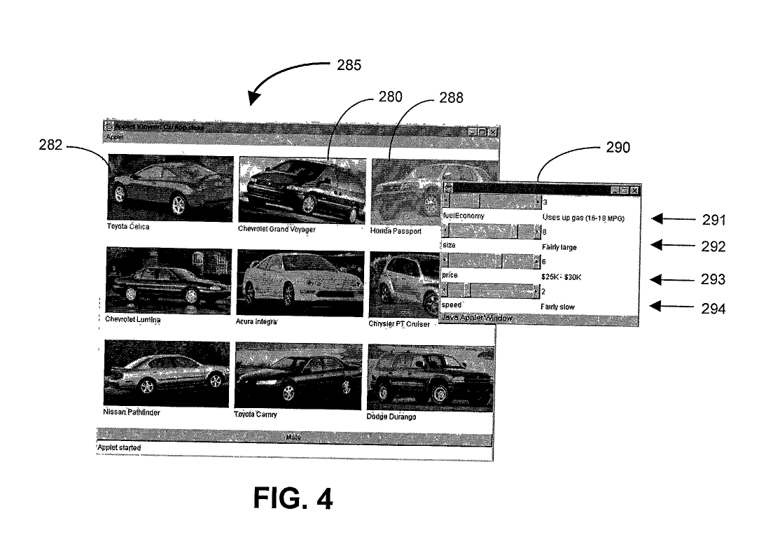

Referring to FIG. 4, this new selection of cars 285 with traits of both the Celica 282 and the Grand Voyager 280 is presented to Beth. Beth is interested in the Honda Passport 288. It is a sports-utility vehicle (SUV), a class of car she had not considered. By clicking the right mouse button when the cursor is on the SWV, a dialog box 290 is displayed that includes information about the Passport's 288 underlying measurable attributes. As shown in the example, there are four measurable attributes considered by this embodiment: fuel economy 291, size 292, price 293, and speed 294. These attributes are demonstrative, and typically there would be other attributes considered by embodiment, most likely many other attributes. Also, the attribute values shown may not accurately reflect the actual values that should be associated with the vehicles used in the example.

As shown in the figure, the Passport 288 has a fuel economy attribute 291 that has a value of 3, meaning here that the Passport gets 16-18 miles per gallon. The size attribute 292 has a value of 8, meaning that the vehicle is fairly large. The price attribute 293 has a value of 6, indicating a price of $25,000 to $35,000. The speed attribute 294 has a value of 2, meaning that the Passport is fairly slow.

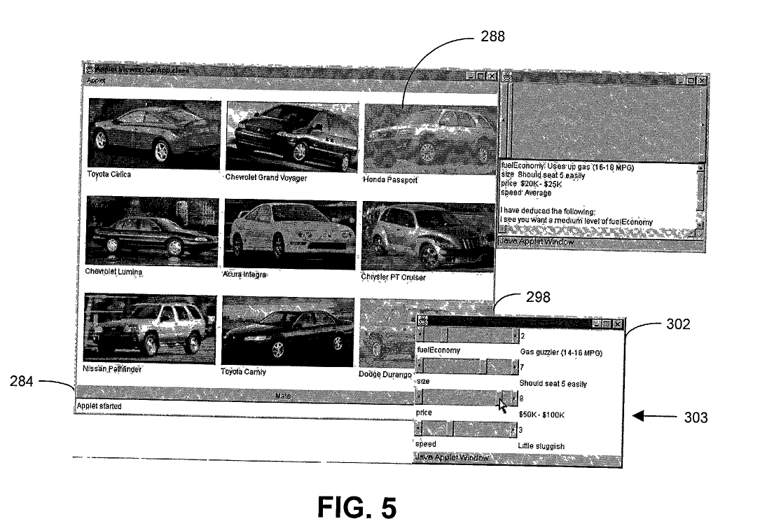

Referring to FIG. 5, in this example, Beth likes the look of the Passport 288 as well as its qualities. Beth also eyes another SWV, the Dodge Durango 298. When Beth uses the right mouse button to click on the Durango 298, a dialog box 302 appears that shows the attributes for the Durango 298. After examining the attributes 302, Beth decides that she can afford a more expensive car. As such, she moves the scrollbar 303 to change the attribute value for price to a value of 9, which is about $60,000. Beth then clicks on the selection initiation button 284 to see another group of vehicles to choose from.

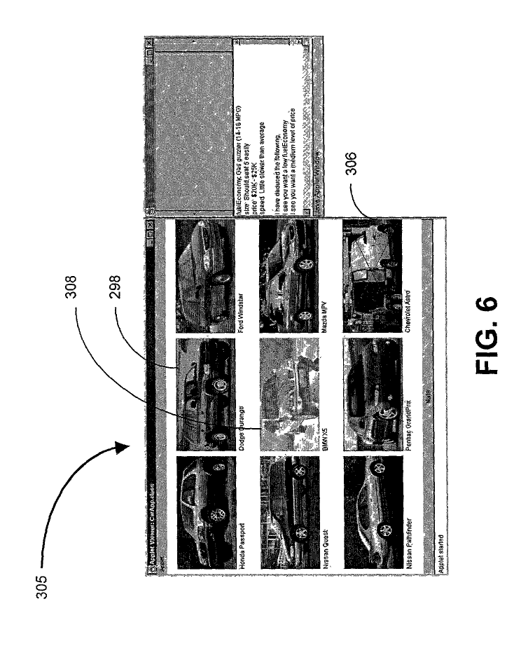

Referring to FIG. 6, Beth now sees a third group of cars 305, consisting primarily of SUVs with a few minivans and large family cars. Beth is impressed with the rather accurate profile suggesting she is less concerned with fuel economy as she is with a large car in her price range. One of the choices, an extra-large van 306 is distasteful to Beth, so she crosses it out by selecting it, then pressing delete. After deleting the van 306, however, Beth examines the remining cars, she notices the BMW X5 308. She finds out more information about the BMW 308, and realizes that this is the car for her. Beth has finished her product search by finding a satisfactory car.

If Beth had continued on with further iterations, perhaps by selecting the BMW 308, and with the van 306 deleted, Beth would have been presented with more cars that were in line with her interests.

From this scenario, several salient points are observed. Beth did not initially know what she was searching for. She could, however, point to vehicles exemplifting the traits she desired. The example embodiment inferred her preferences for a sporty fatily car. Using examples, Beth could express imprecise, relative preferences. Beth initially resigned herself to purchasing a . nivan, yet she was happy when shown examples of Sports-Utility Vehicles, or SUTs. She did not need to know about them to use the user interface, yet she was able to learn about them. Serendipitous exploration of the product space is a useful feature of an embodiment of the invention.

By examining the underlying characteristics of the Honda Passport and the Dodge Durango, Beth learned about the attributes that characterized cars and how these cars rated in each attribute. She also refined her search specification during her interaction with the embodiment of the invention. She started with “a cross between a sports car and a minivan” and then “a SUV”. Using her new knowledge of the product space, she further refined her specification, to “I want an SUV a little more expensive than the Durango, in the $60,000 range.” By expressing her desire for a more expensive SUV than the Dodge Durango, Beth expressed control over the application. A second example of expressing control is her crossing out the fifteen-passenger van she disliked. This ability to control is similar to a physical shopping scenario where Beth maintains complete control because she controls the navigation from one set of products to another and can direct a salesperson.

Variations, modifications, and other implementations of what is described herein will occur to those of ordinary skill in the art without departing from the spirit and the scope of the invention as claimed.

For example, aspects of the invention can incorporate features of other systems. As one example, an embodiment of the invention could be augmented with a collaborative filtering engine. This way, when it suggests exploratory choices, it can make a smart decision using data from other similar users. Also, ontologies or domain-specific information could be used to augment the decision of which products to present to a user.

As another example, the user interface of MDS-I could be integrated with an embodiment of the invention to leverage the exploration capabilities of the modified genetic algorithm and to modify the attribute weights, as well as handling one-sided preferences.

As another example, an embodiment of the invention can allow the user to rate each or some of the products, to provide more information about the user's desires than which are the most/least liked. Likewise, information about user's attribute preferences (i.e., user's who prefer large vehicles don't care about gas mileage) can be used to make better decisions. Domain-specific rules about attributes can be provided to, or deduced by the system. Also, a user may not realize what an attribute represents or its importance. An embodiment of the invention can provide meta-information on the attributes. For example, the user can click on an attribute to bring up a detailed description.

Aspects of the invention also can be used in other applications. Future “smart” applications can use context and implicit profiling along with a mechanism for users to imprecisely state what they want. The personalization elements can be useful, too. While currently, an application looks the same to all users, in the future, applications can customuize themselves to their users.

An embodiment of the invention could coordinate with a web browser search engine. It could, for example, show thumbnnails of news sites, each rated in story length, amount of editorial commentary, and number of pictures. Thus, users can efficiently navigate the web while the system provides good recommended sites while it learns about the user's interests.

Accordingly, the invention is to be defined not by the preceding illustrative description but instead by the spirit and scope of the following claims.

What is claimed is:

1. A method of facilitating a search by a user for a product from among a plurality of products, the products being defined by a set of measurable attributes, each product having a value for each attribute, the method comprising the steps of:
a. facilitating user selection of one or more products;
b. combining the attribute values of the selected one or more products to produce a set of progeny attribute values;
c. selecting, from among the plurality of products, at least one candidate product based on the progeny attribute values; and
d. presenting the at least one candidate product to the user.

2. The method of claim 1 wherein steps (a)-(d) are repeated until a final optimal product is selected.

3. The method of claim 1, further comprising, before step (a), the steps of:
(i) selecting an initial subset of the plurality of products; and
(ii) presenting the initial subset to the user.

4. The method of claim 3 wherein the selecting step (i) comprises selecting randomly an initial subset of the plurality of products.

5. The method of claim 3 wherein the selecting step (i) comprises using a predetermined initial subset that is a well distributed sample of the plurality of products.

6. The method of claim 1 wherein step (a) comprises facilitating user selection of at least one desired products and at least one product that is not desired.

7. The method of claim 6 wherein the selecting step (c) comprises selecting products having attributes simiular to the at least one desired product and unlike the at least one product that is not desired.

8. The method of claim 1 further comprising, before step (b), the steps of:
(i). displaying the attribute values of at least one product; and
(ii). allowing the user to modify the displayed attributes values.

9. The method of claim 8 wherein step (b) comprises combining the attribute values of the selected products and the modified displayed attribute to produce a set of progeny attribute values.

10. The method of claim 1 wherein step (a) comprises facilitating user selection of one or more products from a random subset of the plurality of products.

11. The method of claim 1, wherein step (c) further comprises selecting at least one candidate product based on proximity of candidate product attribute values to progeny attribute values.

12. The method of claim 1, further comprising the step of identifying the attributes that are important to a user by observing at least one user selection;
and wherein step (c) comprises selecting at least one candidate product based on the progeny attribute values and the attributes that are important to the user.

13. The method of claim 12, wherein the at least one user selection comprises at least one current selection and at least one past selection.

14. The method of claim 1, wherein the combining step (b) comprises using a random probability function.

15. The method of claim 1, wherein the combining step (b) comprises, for each measurable attribute:
choosing one of the selected products;
taking the attribute value of the chosen one of the selected products as the progeny attribute value for that measurable attribute.

16. The method of claim 1, wherein the combining step (b) comprises choosing one of the selected products and, for a subset of the measurable attributes:
taking the attribute value of the chosen one of the selected products as the progeny attribute value for that measurable attribute.

17. The method of claim 16 wherein the subset of the measurable attributes comprises all of the measurable attributes.

18. The method of claim 16 wherein the choosing step comprises randomly choosing one of the selected products.

19. The method of claim 1, wherein the combining step (b) comprises, for each measurable attribute:
associating a fraction value with each of the selected products such that the fraction values total 1;
multiplying the attribute value of each of the selected products by the fraction value associated with that product; and
taking the sum of the results of the multiplying step as the progeny attribute value for that measurable attribute.

20. The method of claim 1, wherein the combining step (b) comprises associating a fraction value with each of the selected products such that the fraction values total 1, and, for each of a subset of measurable attributes:
multiplying the attribute value of each of the selected products by the fraction value associated with that product; and
taking the sum of the results of the multiplying step as the progeny attribute value for that measurable attribute.

21. The method of claim 20 wherein the subset of measurable attributes comprises all of the measurable attributes.

22. The method of claim 20 wherein the associating step comprises associating at least one random fraction value with one of the selected products.

23. The method of claim 1 wherein:
the facilitating step (a) is performed by a server computer in communication with a client computer over a computer network, the user interacting with the client computer to select the products; and
step (d) comprises presenting the at least one candidate product to the user by transmitting information describing the at least one candidate product from the server computer over the computer network to the client computer for presentation thereon.

24. The method of claim 23 wherein the server computer comprises a web server, the client computer comprises a web browser, and the computer network comprises the Internet.

25. The method of claim 1 wherein the facilitating step (a) and the presenting step (d) is performed by a single computer.

26. The method of claim 25 wherein the single computer is a kiosk in a retail location.

27. A system for facilitating a search for a product from among a plurality of products, the products being defined by a set of measurable attributes, each product having a value for each attribute, the system comprising:
a. a user interface for facilitating user selection of at least one products;
b. a combination subsystem for combining the attribute values of the selected at least one products to produce a set of progeny attribute values;
c. a selection subsystem for selecting, from among the plurality of products, at least one candidate product based on the progeny attribute values; and
d. a result output for communicating the at least one candidate product to the user.

28. The system of claim 27 wherein the system iterates operation of the user interface, combination subsystem, selection subsystem and the result output until a final optimal product is selected.

29. The system of claim 27 wherein the user interface is for facilitating user selection of at least one desired product and at least one product that is not desired.

30. The system of claim 27 wherein the user interface is also for displaying the attribute values of at least one product; and allowing the user to modify the displayed attributes values.

31. The system of claim 30 wherein the combination subsystem is for combining the attribute values of the selected products and the modified displayed attribute to produce a set of progeny attribute values.

32. The system of claim 27 wherein the user interface is for facilitating user selection of at least one product from a random subset of the plurality of products.

33. The system of claim 27, wherein the selection subsystem is for selecting at least one candidate product based on proximity of candidate product attribute values to progeny attribute values.

34. The system of claim 27, further comprising an observation subsystem for identifying the attributes that are important to a user by observing user selection and wherein the selection subsystem selects at least one candidate product based on the progeny attribute values and the attributes that are important to the user.

35. The system of claim 27, wherein the combination subsystem comprises a random probability function.

36. The system of claim 27, wherein the combination subsystem comprises, for each measurable attribute:
choosing one of the selected products;
taking the attribute value of the chosen one of the selected products as the progeny attribute value for that measurable attribute.

37. The system of claim 27, wherein the combination subsystem chooses one of the selected products and, for a subset of the measurable attributes takes the attribute value of the chosen one of the selected products as the progeny attribute value for that measurable attribute.

38. The system of claim 37 wherein the subset of the measurable attributes comprises all of the measurable attributes.

39. The system of claim 37 wherein the selection subsystem randomnly chooses one of the selected products.

40. The system of claim 27, wherein the combination subsystem, for each measurable attribute, associates a fraction value with each of the selected products such that the fraction values total 1, multiplies the attribute value of each of the selected products by the fraction value associated with that product, and takes the sum of the results of the multiplying step as the progeny attribute value for that measurable attribute.

41. The system of claim 27, wherein the combination subsystem associates a fraction value with each of the selected products such that the fraction values total 1; and, for each of a subset of measurable attributes, multiplies the attribute value of each of the selected products by the fraction value associated with that product, and takes the sum of the results of the multiplying step as the progeny attribute value for that measurable attribute.

42. The system of claim 41 wherein the subset of measurable attributes comprises all of the measurable attributes.

43. The system of claim 41 wherein the combination subsystem associates at least one random fraction value with one of the selected products.

44. The system of claim 27 wherein the system is implemented in a server computer configured for communication over a computer network with a client computer, the user interface and result output being implemented as display instructions originating with the server but communicated to and displayable on the client computer.

45. The system of claim 44 wherein the server computer comprises a web server for generating the display instructions, the instructions being communicated to the client computer via the Internet and displayable on a web browser running on the client computer.

46. The system of claim 27 wherein the system is implemented as a single computer comprising the user interface, combination subsystem, selection subsystem and the result output.

47. The system of claim 46 wherein the single computer comprises a kiosk in a retail location.
